(19) United States
(12) Patent Application Publication
(10) Pub. No.: US 2020/0151951 A1
(43) Pub. Date: May 14, 2020

(54) METHOD AND SYSTEM FOR INSPECTING UPPER OF SHOE

(71) Applicants: SINCERE PIONEER ENTERPRISE CO., LTD., Taichung City (TW); USE ELECTRONICS CO., LTD., Taipei City (TW)

(72) Inventors: Chao-Chung LIAO, Taichung City (TW); Cheng-Yi CHUNG, Taichung City (TW)

(21) Appl. No.: 16/256,925

(22) Filed: Jan. 24, 2019

(30) Foreign Application Priority Data
Nov. 14, 2018 (TW) 107140428

(51) Int. Cl. G06T 17/10; G06T 7/00; A43D 1/08

(52) U.S. Cl. CPC G06T 17/10; A43D 2200/60; A43D 1/08; G06T 7/001

(57) ABSTRACT

A system for inspecting an upper of a shoe includes an optical sub-system and a processor. The optical sub-system captures an image related to a work piece which includes the upper and a last so as to output image data representing the image. The processor receives the image data, establishes a work piece model that is a three-dimensional model of the work piece based on the image data, obtains a cross section of the work piece model, obtains an entry of section data related to the cross section of the work piece model, and compares the entry of section data and an entry of predetermined standard data so as to generate a result of inspection indicating whether the upper is normal.

### CROSS-REFERENCE TO RELATED APPLICATION

This application claims priority of Taiwanese Invention Patent Application No. 107140428, filed on Nov. 14, 2018.

### FIELD

The disclosure relates to a method and a system for inspecting a shoe, and more particularly to a method and a system for inspecting an upper of a shoe.

### BACKGROUND

Referring to FIG. 1, a conventional shoemaking procedure includes the steps of:
pulling an upper 12 around a shoe last 13 so as to mold the upper 12 into a shape of the shoe last 13 (i.e., shoe lasting);
assembling a midsole 111 and the upper 12 so as to form an intermediate product as shown in the middle part of FIG. 1; and
attaching an outsole 112 to the intermediate product to result in the shoe as shown in the right part of FIG. 1, where the midsole 111 and the outsole 112 cooperatively serve as a shoe sole 11 attached to the upper 12.

Conventionally, the step of pulling the upper 12 around the shoe last 13 is performed manually or with the assistance of a machine (not shown), and the quality of molding the upper 12 in this step is crucial to the comfort of wearing the shoe. Therefore, a well experienced craftsman is demanded to check the quality of molding the shoe upper 12. However, it takes a significant amount of time to build up experience of a craftsman, and checking the quality is time consuming and labor intensive. Moreover, individual differences in experience among craftsmen makes quality control difficult.

### SUMMARY

Therefore, an object of the disclosure is to provide a method and a system for inspecting an upper of a shoe that can alleviate at least one of the drawbacks of the prior art.

According to one aspect of the disclosure, the upper is pulled around a last by a shoe lasting machine where the upper and the last cooperatively serve as a work piece. The system includes an optical sub-system and a processor. The optical sub-system is configured to capture at least one image related to the work piece so as to output image data representing the image thus captured. The processor is configured to receive the image data, to establish a work piece model that is a three-dimensional model of the work piece based on the image data, to obtain a cross section of the work piece model along an imaginary cutting plane passing through an imaginary section line, to obtain an entry of section data related to the cross section of the work piece model, and to compare the entry of section data and an entry of predetermined standard data so as to generate a result of inspection indicating whether the upper is normal.

According to another aspect of the disclosure, the method is to be implemented by the processor that is previously described. The method includes steps of:
a) establishing, based on at least one image related to the work piece, a work piece model that is a three-dimensional model of the work piece;
b) obtaining a cross section of the work piece model along an imaginary cutting plane passing through an imaginary section line;
c) obtaining an entry of section data related to the cross section of the work piece model; and
d) comparing the entry of section data and an entry of predetermined standard data so as to generate a result of inspection indicating whether the upper is normal.

### BRIEF DESCRIPTION OF THE DRAWINGS

Other features and advantages of the disclosure will become apparent in the following detailed description of the embodiments with reference to the accompanying drawings, of which:

FIG. 1 is a set of perspective views cooperatively illustrating a shoemaking procedure;

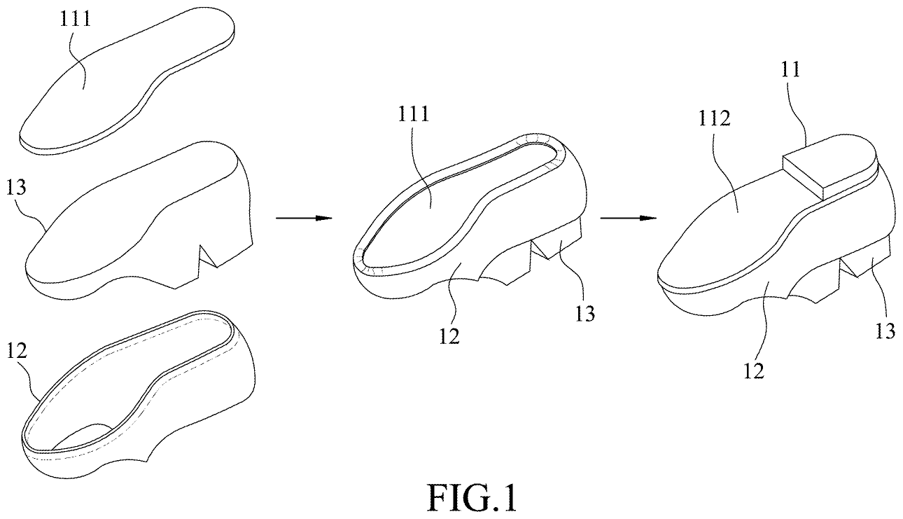

FIG. 2 is a schematic diagram illustrating a first embodiment of a system for inspecting an upper of a shoe according to the disclosure;

FIG. 3 is a schematic diagram illustrating an embodiment of two image capturing devices of an optical sub-system of the first embodiment of the system according to the disclosure;

FIG. 4 is a flow chart illustrating a first embodiment of a method for inspecting an upper of a shoe according to the disclosure;

FIG. 5 is a flow chart illustrating a model establishment procedure of the first embodiment of the method according to the disclosure;

FIG. 6 is a schematic diagram illustrating an example of a work piece model established by the first embodiment of the method according to the disclosure;

FIG. 7 is a flow chart illustrating an inspection procedure of the first embodiment of the method according to the disclosure;

FIG. 8 is a schematic diagram illustrating an embodiment of a cross section of the work piece model along an imaginary cutting plane passing through an imaginary section line (L) shown in FIG. 6;

FIG. 9 is a schematic diagram illustrating examples of section data related to the cross section and corresponding examples of predetermined standard data utilized by the first embodiment of the method according to the disclosure;

FIG. 10 is a schematic diagram illustrating a second embodiment of the system according to the disclosure;

FIG. 11 is a schematic diagram illustrating an example of an image captured by an optical sub-system of the second embodiment of the system according to the disclosure; and

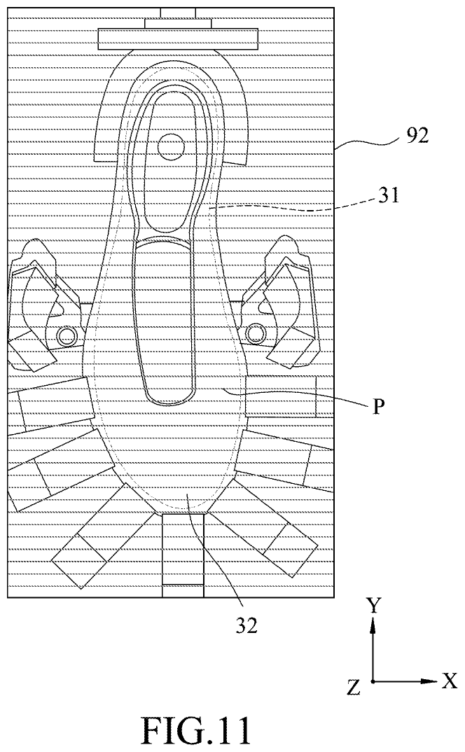

FIG. 12 is a flow chart illustrating the model establishment procedure of the second embodiment of the method according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

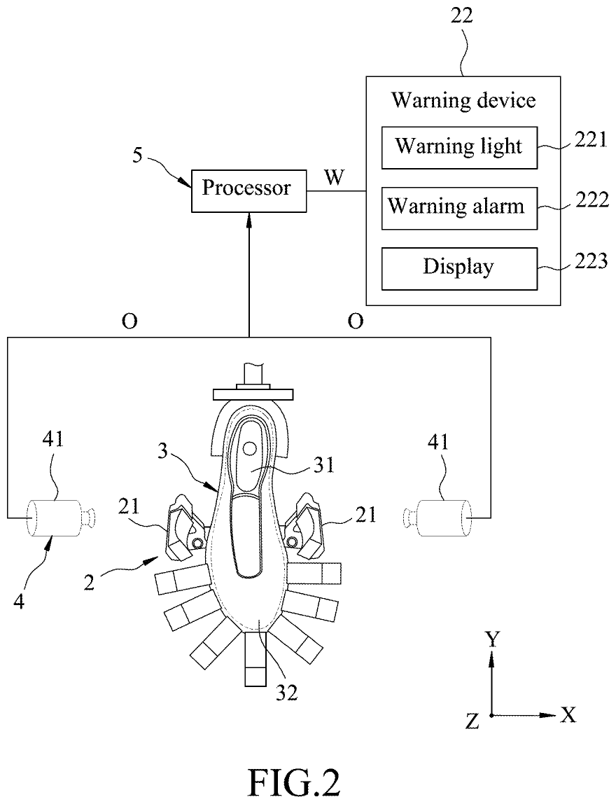

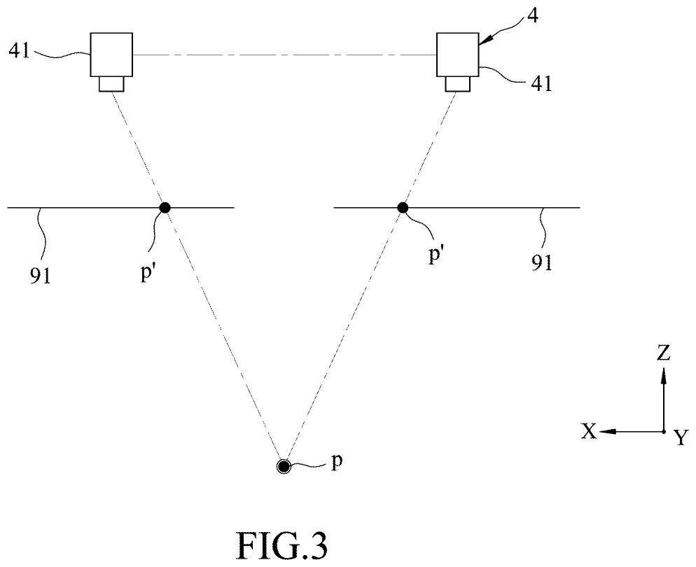

Referring to FIGS. 2 and 3, a first embodiment of a system for inspecting an upper 32 of a shoe according to the disclosure is illustrated. The upper 32 is pulled around a last 31 by a shoe lasting machine 2 where the upper 32 and the last 31 cooperatively serve as a work piece 3. The shoe lasting machine 2 includes lasting pincers 21 for gripping the upper 32, and a warning device 22 that includes a warning light 221, a warning alarm 222 and a display 223. The system includes an optical sub-system 4, and a processor 5 that is connected to the warning device 22 and the optical sub-system 4 by a wired or wireless connection.

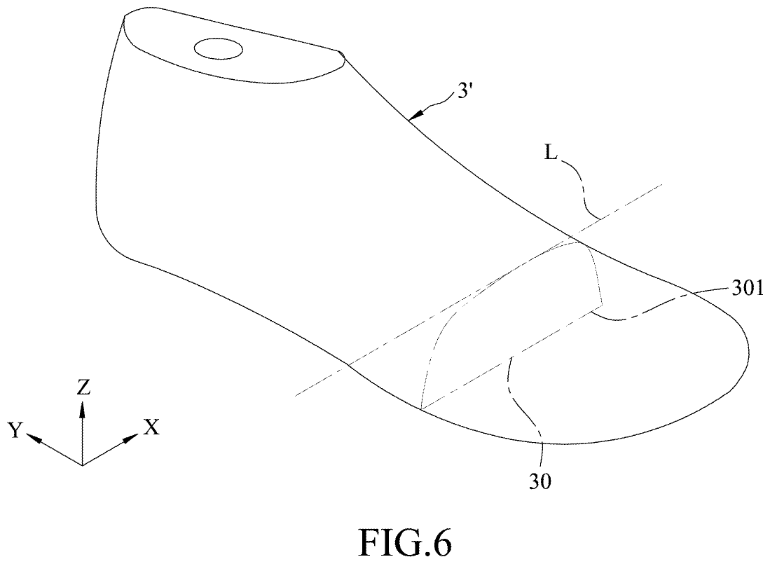

Referring to FIGS. 3, 6, 8 and 9, the optical sub-system 4 is configured to capture at least one image 91 related to the work piece 3 so as to output image data (O) representing the image 91 thus captured. As shown in FIG. 6, the processor 5 is configured to receive the image data (O), and to establish a work piece model 3′ that is a three-dimensional model of the work piece 3 based on the image data (O). In addition, the processor 5 is configured to obtain a cross section 30 of the work piece model 3′ along an imaginary cutting plane passing through an imaginary section line (L), to obtain an entry of section data (D) related to the cross section 30 of the work piece model 3′, and to compare the entry of section data (D) and an entry of predetermined standard data (T) so as to generate a result of inspection indicating whether the upper 32 is normal, where the entry of predetermined standard data (T) is established based on a three-dimensional model of a standard work piece where an upper is pulled around the last 31 properly. The processor 5 is further configured to, when it is indicating by the result of inspection thus generated that the upper 32 is abnormal, generate a warning signal (W) to control the warning device 22 to output sound, light and/or a text/graphics message. In this embodiment, the warning light 221 is configured to be controlled by the warning signal (W) to emit light. The warning alarm 222 is configured to be controlled by the warning message (W) to play sound. The display 223 is configured to be controlled by the warning signal (W) to display a text/graphics message. In one embodiment, the warning signal (W) is a digital signal generated by the processor 5 and to be transmitted via a communication module to a remote electronic device, such as a mobile phone, to notify that the upper 32 is abnormal. Consequently, upon being notified by the warning device 22 or the electronic device, the responsible person may be able to take appropriate actions, such as to adjust the relative position of the upper 32 to the last 31 via the lasting pincers 21, or to remove the work piece 3 from the shoe lasting machine 2.

Specifically speaking, referring to FIG. 3, in the first embodiment of the system according to the disclosure, the optical sub-system 4 includes two image capturing devices 41 which are located respectively at two fixed locations and are spaced apart from each other, and which are connected to the processor 5. Each of the image capturing devices 41 is configured to capture an image 91 of the work piece 3, and to output the image data (O) representing the image 91 of the work piece 3 to the processor 5 so as to enable the processor 5 to obtain the image 91 of the work piece 3 based on the image data (O). In one embodiment, each of the image capturing devices 41 is a camera device.

The processor 5 is configured to compare the two images 91 of the work piece 3 to obtain plural pairs of corresponding image points (p′) in the two images 91 (only one pair is shown). For each of the pairs of corresponding image points (p′), the processor 5 is configured to determine a disparity of the pair of corresponding image points (p′), and to calculate a set of spatial coordinates of a common point (p) in a three-dimensional space based on the disparity and according to triangulation (such as the computer vision triangulation technique), where the pair of corresponding image points (p′) are projections of the common point (p) in the two images 91. In this embodiment, the set of spatial coordinates of the common point (p) is represented as P(x,y,z) in a Cartesian coordinate system, but implementation of representation of the set of spatial coordinates of the common point (p) is not limited to the disclosure herein and may vary in other embodiments. The processor 5 is configured to obtain a point cloud associated with the work piece 3, where the point cloud is formed by multiple common points (p) each correlating to a respective one of the pairs of corresponding image points (p′) in the three-dimensional space, and to establish the work piece model 3′ based on the set of spatial coordinates of the common points (p) in the point cloud.

It is worth to note that implementations of calculating the set of spatial coordinates of the common point (p) and establishing the work piece model 3′ have been well known to one skilled in the relevant art, e.g., technologies of computer stereo vision, so detailed explanation of the same is omitted herein for the sake of brevity.

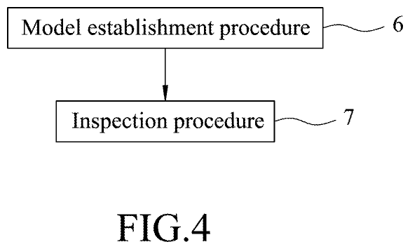

Referring to FIG. 4, a first embodiment of a method for inspecting the upper 32 of the shoe is illustrated. The first embodiment of the method is to be implemented by the processor 5 of the first embodiment of the system that is previously described. The processor 5 of the system executes application software so as to perform procedures of the method. The method includes a model establishment procedure 6 and an inspection procedure 7.

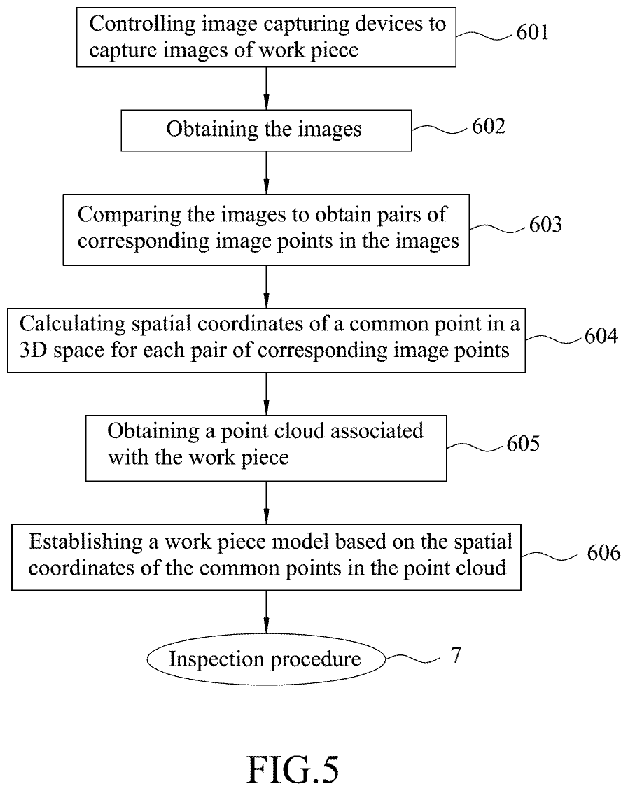

Referring to FIG. 5, the model establishment procedure 6 includes steps 601 to 606 described as follows.

In step 601, the processor 5 controls each of the two image capturing devices 41 that are spaced apart from each other to capture an image 91 of the work piece 3, and to output image data (O) representing the image 91 of the work piece 3 to the processor 5.

In step 602, the processor 5 obtains the two images 91 of the work piece 3 from the image data (O) received from the two image capturing devices 41.

In step 603, the processor 5 compares the two images 91 of the work piece 3 to obtain plural pairs of corresponding image points (p′) in the two images 91. It is noted that only one pair of corresponding image points (p′) is illustrated in FIG. 3 for conciseness.

In step 604, for each of the pairs of corresponding image points (p′), the processor 5 determines a disparity of the pair of corresponding image points (p′), and calculates a set of spatial coordinates of a common point (p) corresponding to the pair of corresponding image points (p′) in three-dimensional space based on the disparity and according to computer vision triangulation techniques, where the pair of corresponding image points (p′) are projections of the common point (p) in the two images 91.

In step 605, the processor 5 obtains a point cloud associated with the work piece 3, where the point cloud is formed by the common points (p) of the respective pairs of corresponding image points (p′) in the three-dimensional space.

In step 606, the processor 5 establishes the work piece model 3′ based on the set of spatial coordinates of the common points (p) in the point cloud. Then, a flow of procedure proceeds to the inspection procedure 7.

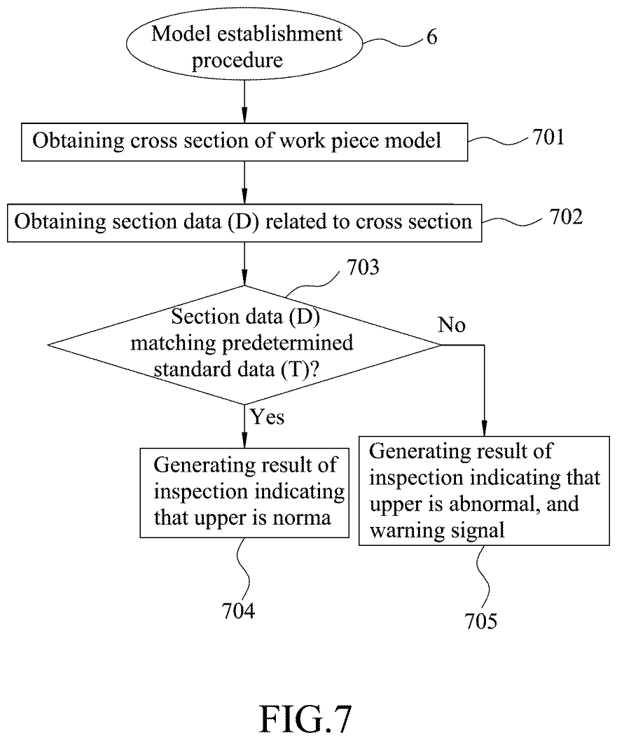

Referring to FIG. 7, the inspection procedure 7 includes steps 701 to 705 described as follows.

In step 701, after the system performs optical scanning on the work piece 3 so as to establish the work piece model 3′ that is the three-dimensional model of the work piece 3 in the model establishment procedure 6, the processor 5 obtains the cross section 30 of the work piece model 3′ along the imaginary cutting plane passing through the imaginary section line (L) on an X-Z plane as shown in FIG. 6.

In step 702, the processor 5 obtains an entry of section data (D) related to the cross section 30 of the work piece model 3′.

In step 703, the processor 5 compares the entry of section data (D) and an entry of predetermined standard data (T) so as to determine whether the entry of section data (D) matches the entry of predetermined standard data (T). When it is determined that the entry of section data (D) matches the entry of predetermined standard data (T), the flow of procedure of this method proceeds to step 704. Otherwise, the flow of procedure proceeds to step 705.

In step 704, the processor 5 generates the result of inspection indicating that the upper 32 is normal. Based on the result of inspection, the shoe lasting machine 2 is permitted to proceed to procedures of glue spreading and sole attaching.

In step 705, the processor 5 generates the result of inspection indicating that the upper 32 is abnormal. Furthermore, the processor 5 generates the warning signal (W) to control the warning device 22 to output sound, light, and/or a text/graphics message. Alternatively, the warning signal (W) may be a digital signal to be transmitted to an electronic device for notification of the result of inspection.

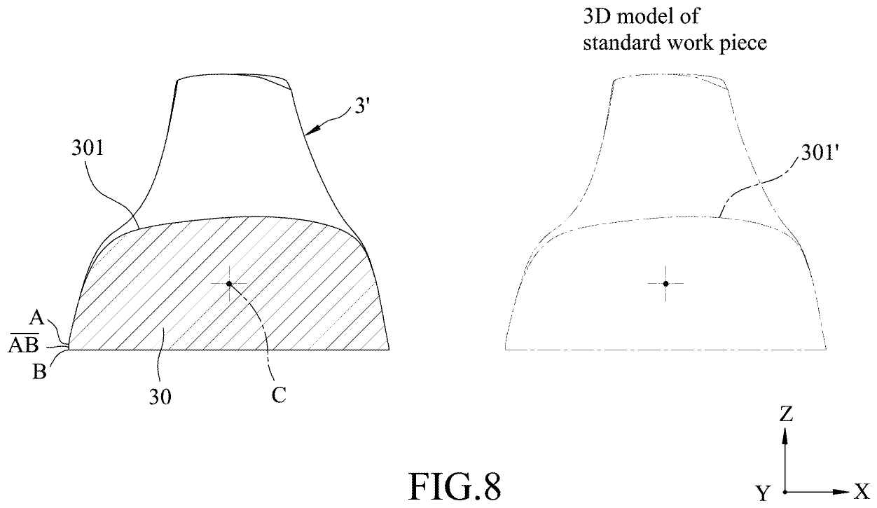

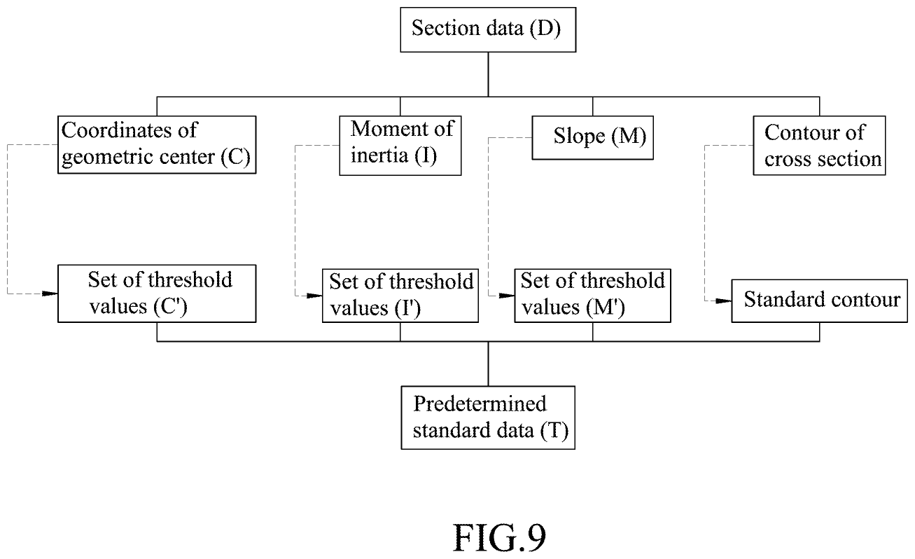

Referring to FIGS. 8 and 9, in one embodiment, the entry of section data (D) related to the cross section 30 of the work piece model 3′ includes a set of coordinates of a geometric center (C) of the cross section 30 of the work piece model 3′. In this embodiment, the set of coordinates of the geometric center (C) is represented as C(x,y,z) in the Cartesian coordinate system, but the set of coordinates of the geometric center (C) may be represented in other forms in other embodiments, and this disclosure is not limited in this respect. In this embodiment, the entry of predetermined standard data (T) is a set of threshold values (C′) defining an allowable range for the coordinates of the geometric center. When it is determined by the processor 5 that the set of coordinates of the geometric center (C) of the cross section 30 of the work piece model 3′ is outside of the allowable range, the result of inspection thus generated indicates that the upper 32 is abnormal. For example, in a scenario that the set of threshold values (C′) is defined as C′(x,y,z|21≤x≤22,11≤y≤12,31≤z≤32), the upper 32 will be determined to be normal when the set of coordinates of the geometric center (C) is C(x,y,z)=(21,12,31.5), and to be abnormal when the set of coordinates of the geometric center (C) is C(x,y,z)=(23,19,30).

Referring to FIGS. 8 and 9, in one embodiment, the entry of section data (D) related to the cross section 30 of the work piece model 3′ includes a moment of inertia (I) of the cross section 30 of the work piece model 3′. In this embodiment, the moment of inertia (I) is the polar moment of inertia, and is calculated as the double integral of the square of a radial coordinate of an infinitesimal element of an area of the cross section 30 over the area of the cross section 30 in a polar coordinate system, but implementation of the same is not limited to the disclosure herein and may vary in other embodiments. In this embodiment, the entry of predetermined standard data (T) is a set of threshold values (I′) defining an allowable range for the moment of inertia. When it is determined by the processor 5 that the moment of inertia (I) of the cross section 30 of the work piece model 3′ is outside of the allowable range, the result of inspection thus generated indicates that the upper 32 is abnormal. For example, in a scenario that the set of threshold values (I′) is defined as 50≤I′≤55, the upper 32 will be determined to be normal when the moment of inertia (I) is 53, and to be abnormal when the moment of inertia (I) is 56.

Referring to FIGS. 8 and 9, in one embodiment, the entry of section data (D) related to the cross section 30 of the work piece model 3′ includes a slope (M) of a line passing through predefined two points on a contour 301 of the cross section 30 of the work piece model 3′. In this embodiment, the slope (M) is implemented to be a slope of a unit-length secant line A̅B̅ passing through points A and B on the contour 301 as shown in FIG. 8, but implementation of the slope (M) and selection of the predefined two points are not limited to the disclosure herein and may vary in other embodiments. In this embodiment, the entry of predetermined standard data (T) is a set of threshold values (M′) defining an allowable range for the slope. When it is determined by the processor 5 that the slope (M) of the line passing through the predefined two points on the contour 301 of the cross section 30 of the work piece model 3′ is outside of the allowable range, the result of inspection thus generated indicates that the upper 32 is abnormal. For example, in a scenario that the set of threshold values (M′) is defined as 3≤M′≤4, the upper 32 will be determined to be normal when the slope (M), i.e., the slope of the line A̅B̅, is 3, and abnormal when the slope (M) is 5.

Referring to FIGS. 8 and 9, in one embodiment, the entry of section data (D) related to the cross section 30 of the work piece model 3′ includes the contour 301 of the cross section 30 of the work piece model 3′. In this embodiment, the entry of predetermined standard data (T) is a standard contour 301′. When it is determined by the processor 5 that the contour 301 of the cross section 30 of the work piece model 3′ does not match the standard contour 301′ according to a contour matching method, the result of inspection thus generated indicates that the upper 32 is abnormal.

It is worth to note that implementation of the comparison between the entry of section data (D) and the entry of predetermined standard data (T) is not limited to comparison in a single aspect, i.e., only one of the geometric center (C), the moment of inertia (I), the slope (M) and the contour 301 is taken into account. In some embodiments, the comparison may be implemented to be performed in multiple aspects, i.e., two or more of the geometric center (C), the moment of inertia (I), the slope (M) and the contour 301 may be taken into account for inspection of a single upper 32, or alternatively, multiple cross sections respectively on multiple X-Z planes along a Y axis may be extracted from the single work piece model 3′ followed by their respective comparison processes, such that the result of inspection may be more accurate.

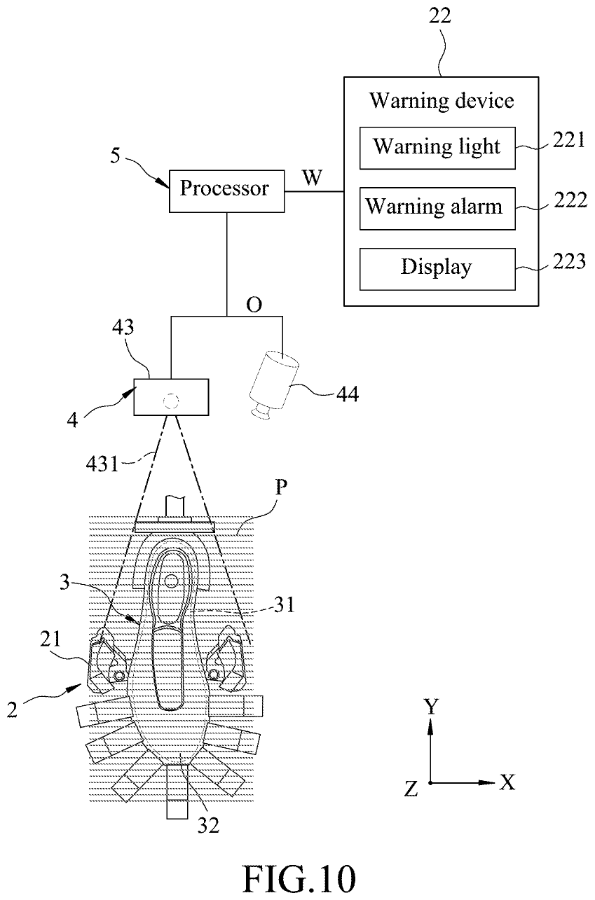

Referring to FIG. 10, a second embodiment of the system for inspecting the upper 32 of the shoe according to the disclosure is illustrated. The second embodiment of the system according to the disclosure is similar to the first embodiment, but is different in what are described as follows.

Referring to FIG. 10, the optical sub-system 4 includes a light source 43 and an image capturing device 44 that are located respectively at two fixed locations and are spaced apart from each other. The processor 5 is electrically connected to the light source 43 and the image capturing device 44.

The light source 43 is configured to emit a structured light beam 431 of a predefined pattern toward the upper 32 to form a projected pattern (P) on the work piece 3. The projected pattern (P) appears to be a distortion of the predefined pattern from viewpoints other than that of the light source 43 due to the three-dimensionally varying surface of the work piece 3. The predefined pattern may consist of multiple stripes, or be a single light stripe, in which case the light source 43 is configured to scan the work piece 3 with the single-stripe structured light beam 431, but implementation of the predefined pattern of the structured light beam 431 is not limited to the disclosure herein and may vary in other embodiments. The light source 43 may include one of a laser projector and a digital light processing (DLP) projector, but implementation is not limited to the disclosure herein and may vary in other embodiments. In this embodiment, the light source 43 includes a DLP projector for emitting the structured light beam 431 with the predefined pattern consisting of multiple stripes and covering the whole work piece 3, and an angle of projection of the structured light beam 431 emitted by the DLP projector is adjustable without having to physically move the light source 43 around.

The image capturing device 44 is configured to obtain an image 92 of the projected pattern (P) formed on the work piece 3, and to output image data (O) representing the image 92 of the projected pattern (P) to the processor 5 so as to enable the processor (5) to obtain the image 92 of the projected pattern (P) from the image data (O).

The processor 5 is configured to calculate spatial coordinates of each element (e.g., each stripe) of the projected pattern (P) in the image 92 based on a degree of deformation of the projected pattern (P) in the image 92 (with respect to the non-distorted predefined pattern of the structured light beam 431) and a positional relationship among the light source 43, the image capturing device 44 and the work piece 3, and to establish the work piece model 3′ as shown in FIG. 6 based on the spatial coordinates of the elements of the projected pattern (P) in the image 92.

It should be noted that since implementation of establishing the work piece model 3′ in the three-dimensional space based on technologies of structured light (e.g., structured light 3D scanning) has been well known to one skilled in the relevant art, detailed explanation of the same is omitted herein for the sake of brevity.

Next, a second embodiment of the method according to the disclosure is discussed. The second embodiment of the method is to be implemented by the processor 5 of the second embodiment of the system that is previously described. As shown in FIG. 4, similar to the first embodiment of the method, the second embodiment of the method includes the model establishment procedure 6 and the inspection procedure 7 as well. However, the model establishment procedure 6 in the second embodiment of the method is different from that of the first embodiment.

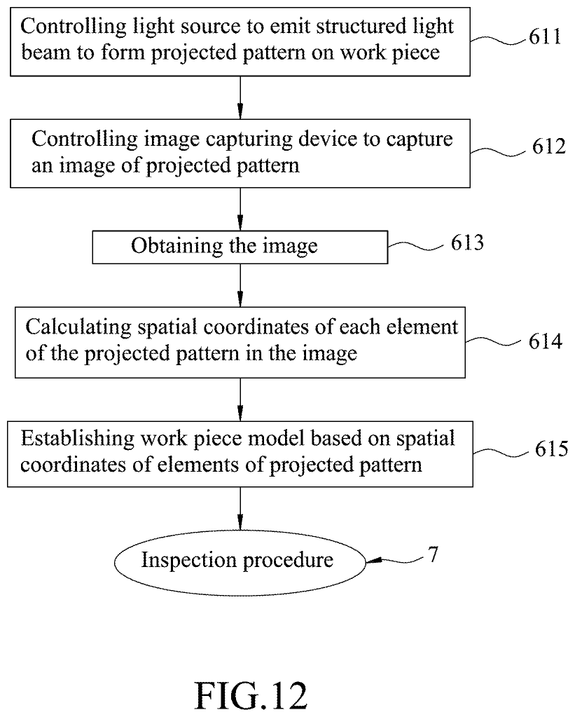

Referring to FIG. 12, the model establishment procedure 6 in the second embodiment of the method according to the disclosure includes steps 611 to 615 described as follows.

In step 611, the processor 5 controls the light source 43 to emit the structured light beam 431 onto the upper 32 to form a projected pattern (P) on the work piece 3.

In step S612, the processor 5 controls the image capturing device 44 to capture an image 92 of the projected pattern (P) formed on the work piece 3, and to output image data (O) representing the image 92 of the projected pattern (P) to the processor 5.

In step 613, the processor 5 obtains, from the image data (O), the image 92 of the projected pattern (P) formed on the work piece 3.

In step 614, the processor 5 calculates spatial coordinates of each element of the projected pattern (P) based on a degree of deformation of the projected pattern (P) in the image 92 and the positional relationship among the light source 43, the image capturing device 44 and the work piece 3.

In step 615, the processor 5 establishes the work piece model 3′ based on the spatial coordinates of the elements of the projected pattern (P). Subsequently, the inspection procedure 7 as shown in FIG. 7 and explained above may be performed to determine whether the upper 32 is normal or abnormal.

To sum up, the system and the method for inspecting an upper of a shoe according to the disclosure utilize an optical sub-system to capture an image related to a work piece that includes the upper and a last, and utilize a processor to establish a work piece model based on the image, to obtain a cross section of the work piece model, and to generate a result of inspection based on a comparison between an entry of section data related to the cross section and an entry of predetermined standard data. Therefore, adjustment can be made to a position of the upper relative to the last in time when it is indicated by the result of inspection that the upper is abnormal, reducing failure rate of the step of pulling the upper around the last and improving quality of shoe production. Accordingly, materials of the upper may be efficiently used. Moreover, inspection of the upper performed by the system and the method according to the disclosure is automatic and is more efficient than the conventional manual approach, and may be able to generate the result of inspection that is more consistent and precise than that of the conventional manual approach. Consequently, labor cost is reduced and quality control may be enhanced.

In the description above, for the purposes of explanation, numerous specific details have been set forth in order to output a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for inspecting an upper of a shoe, the upper being pulled around a last by a shoe lasting machine where the upper and the last cooperatively serve as a work piece, the method to be implemented by a processor and comprising:
a) establishing, based on at least one image related to the work piece, a work piece model that is a three-dimensional model of the work piece;
b) obtaining a cross section of the work piece model along an imaginary cutting plane passing through an imaginary section line;
c) obtaining an entry of section data related to the cross section of the work piece model; and
d) comparing the entry of section data and an entry of predetermined standard data so as to generate a result of inspection indicating whether the upper is normal.

2. The method as claimed in claim 1, wherein step a) includes sub-steps of:
a-1) obtaining two images of the work piece which are captured by two image capturing devices spaced apart from each other;
a-2) comparing the two images of the work piece to obtain plural pairs of corresponding image points in the two images;
a-3) for each of the pairs of corresponding image points, determining a disparity of the pair of corresponding image points, and calculating spatial coordinates of a common point (p) in a three-dimensional space based on the disparity and according to triangulation, where the pair of corresponding image points are projections of the common point in the two images;
a-4) obtaining a point cloud associated with the work piece, where the point cloud is formed by the common points each correlating to a respective one of the pairs of corresponding image points in the three-dimensional space; and
a-5) establishing the work piece model based on the spatial coordinates of the common points in the point cloud.

3. The method as claimed in claim 1, wherein step a) includes sub-steps of:
a-1′) controlling a light source device to emit a structured light beam on the upper to form a projected pattern on the work piece;
a-2′) obtaining an image of the projected pattern formed on the work piece;
a-3′) calculating spatial coordinates of each of elements of the projected pattern based on a degree of deformation of the projected pattern in the image and a positional relationship between the light source module (43) and the work piece; and
a-4′) establishing the work piece model based on the spatial coordinates of the elements of the projected pattern.

4. The method as claimed in claim 3, wherein:
the structured light beam has a predefined pattern that is one of a pattern consisting of multiple stripes and a single light stripe; and
the structured light beam is emitted from one of a laser projector and a digital light processing (DLP) projector.

5. The method as claimed in claim 1, wherein:
the entry of section data related to the cross section of the work piece model includes coordinates of a geometric center of the cross section of the work piece model;
the entry of predetermined standard data is a set of threshold values defining an allowable range; and
when it is determined that the coordinates of the geometric center of the cross section of the work piece model is outside of the allowable range, the result of inspection thus generated indicates that the upper is abnormal.

6. The method as claimed in claim 1, wherein:
the entry of section data related to the cross section of the work piece model includes a moment of inertia of the cross section of the work piece model;
the entry of predetermined standard data is a set of threshold values defining an allowable range; and
when it is determined that the moment of inertia of the cross section of the work piece model is outside of the allowable range, the result of inspection thus generated indicates that the upper is abnormal.

7. The method as claimed in claim 1, wherein:
the entry of section data related to the cross section of the work piece model includes a slope of a line passing through predefined two points on a contour of the cross section of the work piece model;
the entry of predetermined standard data is a set of threshold values defining an allowable range; and
when it is determined that the slope of the line passing through the predefined two points on the contour of the cross section of the work piece model is outside of the allowable range, the result of inspection thus generated indicates that the upper is abnormal.

8. The method as claimed in claim 1, wherein:
the entry of section data related to the cross section of the work piece model includes a contour of the cross section of the work piece model;
the entry of predetermined standard data is a standard contour; and
when it is determined that the contour of the cross section of the work piece model does not match the standard contour according to a contour matching method, the result of inspection thus generated indicates that the upper is abnormal.

9. The method as claimed in claim 1, subsequent to step d), further comprising:
e) generating, when it is indicated by the result of inspection thus generated that the upper is abnormal, a warning signal to control a warning device to output one of sound, light and a text or graphics message, or to be transmitted to an electronic device to notify that the upper is abnormal.

10. A system for inspecting an upper of a shoe, the upper being pulled around a last by a shoe lasting machine where the upper and the last cooperatively serve as a work piece, said system comprising:
an optical sub-system configured to capture at least one image related to the work piece so as to output image data representing the image thus captured; and
a processor configured to receive the image data, to establish a work piece model that is a three-dimensional model of the work piece based on the image data, to obtain a cross section of the work piece model along an imaginary cutting plane passing through an imaginary section line, to obtain an entry of section data related to the cross section of the work piece model, and to compare the entry of section data and an entry of predetermined standard data so as to generate a result of inspection indicating whether the upper is normal.

11. The system as claimed in claim 10, wherein:
said optical sub-system includes two image capturing devices which are located respectively at two fixed locations and are spaced apart from each other, and each of which is configured to capture an image of the work piece, and to output the image data representing the image of the work piece to said processor so as to enable said processor to obtain the image of the work piece; and
said processor is configured to
compare the two images of the work piece from the two image capturing devices to obtain plural pairs of corresponding image points in the two images,
for each of the pairs of corresponding image points, determine a disparity of the pair of corresponding image points, and calculate spatial coordinates of a common point in a three-dimensional space based on the disparity and according to triangulation, where the pair of corresponding image points are projections of the common point in the two images,
obtain a point cloud associated with the work piece, where the point cloud is formed by the common points each correlating to a respective one of the pairs of corresponding image points in the three-dimensional space, and
establish the work piece model based on the spatial coordinates of each of the common points in the point cloud.

12. The system as claimed in claim 10, wherein:
said optical sub-system includes a light source and an image capturing device that are located respectively at two fixed locations and are spaced apart from each other;
said light source is configured to emit a structured light beam onto the upper to form a projected pattern on the work piece;
said image capturing device is configured to capture an image of the projected pattern formed on the work piece, and to output the image data related to the image of the projected pattern to said processor so as to enable said processor to obtain the image of the projected pattern; and
said processor is configured to calculate spatial coordinates of each of elements of the projected pattern based on a degree of deformation of the projected pattern in the image and a positional relationship between said light source and the work piece, and to establish the work piece model based on the spatial coordinates of the elements of the projected pattern.

13. The system as claimed in claim 12, wherein:
said light source includes one of a laser projector and a digital light processing (DLP) projector that emits the structured light beam having a predefined pattern that is one of a pattern consisting of multiple stripes and a single light stripe.

14. The system as claimed in claim 10, wherein:
the entry of section data related to the cross section of the work piece model includes coordinates of a geometric center of the cross section of the work piece model;
the entry of predetermined standard data is a set of threshold values defining an allowable range; and
said processor is configured to, when it is determined that the coordinates of the geometric center of the cross section of the work piece model is outside of the allowable range, generate the result of inspection indicating that the upper is abnormal.

15. The system as claimed in claim 10, wherein:
the entry of section data related to the cross section of the work piece model includes a moment of inertia of the cross section of the work piece model;
the entry of predetermined standard data is a set of threshold values defining an allowable range; and
said processor is configured to, when it is determined that the moment of inertia of the area of the cross section of the work piece model is outside of the allowable range, generate the result of inspection indicating that the upper is abnormal.

16. The system as claimed in claim 10, wherein:
the entry of section data related to the cross section of the work piece model includes a slope of a line passing through predefined two points on a contour of the cross section of the work piece model;
the entry of predetermined standard data is a set of threshold values defining an allowable range; and
said processor is configured to, when it is determined that the slope of the line passing through the predefined two points on the contour of the cross section of the work piece model is outside of the allowable range, generate the result of inspection indicating that the upper is abnormal.

17. The system as claimed in claim 10, wherein:
the entry of section data related to the cross section of the work piece model includes a contour of the cross section of the work piece model;
the entry of predetermined standard data is a standard contour; and
said processor is configured to, when it is determined that the contour of the cross section of the work piece model does not match the standard contour according to a contour matching method, generate the result of inspection indicating that the upper is abnormal.

18. The system as claimed in claim 10, further comprising:
a warning device,
wherein said processor is further configured to, when it is indicating by the result of inspection thus generated that the upper is abnormal, generate a warning signal to control said warning device to output one of sound, light and a text or graphics message, or to be transmitted to an electronic device to notify that the upper is abnormal.
